(19) United States
(12) Patent Application Publication
(10) Pub. No.: US 2023/0002702 A1
(43) Pub. Date: Jan. 5, 2023

(54) COLOUR CARE DETERGENT COMPOSITIONS

(71) Applicant: The Procter & Gamble Company, Cincinnati, OH (US)

(72) Inventors: FRANCESCO BARBERO, Torino (IT); Giulia Ottavia Bianchetti, BRUSSELS (BE); Camilla Maria Cova, SESTO FIORENTINO (IT); Renae Dianna Fossum, Middletown, OH (US); Ming Tang, Beijing (CN); Phillip Kyle Vinson, Fairfield, OH (US); Debora Berti, SESTO FIORENTINO (IT)

(21) Appl. No.: 17/846,336

(22) Filed: Jun. 22, 2022

(30) Foreign Application Priority Data
Jun. 24, 2021 (CN) PCT/CN2021/101948

(51) Int. Cl. C11D 1/94; C11D 1/29; C11D 1/79; C11D 3/37

(52) U.S. Cl. CPC C11D 1/94; C11D 1/29; C11D 1/79; C11D 3/3788

(57) ABSTRACT

The need for a detergent composition which provides reduced dye transfer to co-washed fabrics, but also reduced dye fading during laundering is met by formulating the detergent composition with a combination of a branched nonionic surfactant and a dye transfer inhibition (DTI) polymer.

### FIELD OF THE INVENTION

Laundry detergent compositions, especially liquid laundry detergent compositions or unit dose articles providing improved care of coloured fabric.

### BACKGROUND OF THE INVENTION

Laundry detergent compositions are formulated to provide good cleaning to fabrics: To keep white fabrics white, and to keep coloured fabrics bright. The laundry detergent compositions are also typically formulated to remove stains and soils. However, in addition to removing soils, the laundry detergent compositions have been known to also remove dyes from coloured fabrics, resulting in fading of coloured fabrics. Furthermore, these removed dyes can transfer onto other fabrics during the laundry process, resulting in undesired fabric discoloration.

In order to limit the transfer of such dyes to co-washed fabrics, dye-transfer inhibiting (DTI) polymers are often incorporated into detergent compositions marketed for cleaning coloured fabrics. Typical dye-transfer inhibitors are typically based on polymers such as polyvinyl pyrrolidone homopolymers (PVP), polyvinylimidazole (PVI), polyvinyl pyrrolidone/polyvinyl imidazole copolymers (PVP/PVI), and poly-4-vinylpyridine N-oxide (PVNO), and poly(vinylpyrrolidone) co-poly(vinylpyridine-N-oxide) (PVP/PVNO) polymers, which have typically included relatively high levels of vinyl pyrrolidone (“VP”). However, while such DTI polymers reduce dye-transfer to co-washed fabric, they do not prevent dye bleeding from fabrics which leads to dye-fading. Indeed, it has been found that during laundering, many fabric-dyes partition between the fabric and wash-liquor, and further that the sequestering of dyes in the wash liquor by the DTI polymer has been found to increase the amount of dye partitioning into the wash liquour. As such, while DTI polymers prevent dye transfer to co-washed fabrics during laundering, they have been found to also increase dye-fading.

As such, a need remains for a detergent composition which provides reduced dye redeposition to co-washed fabrics, but also reduced dye fading during laundering.

WO2010025116A1 relates to stable color maintenance and/or rejuvenation compositions comprising at least one cationic polymer and anionic surfactant, and methods for providing the same. WO2013070560A1 relates to surface treatment compositions comprising certain cationic polymer(s), anionic surfactant, one or more shielding salts and hydrophobic association disruptor, the surface treatment compositions comprises at least 6% by weight of cationic polymer, at least 6% by weight anionic surfactant, and at least 4% by weight of the shielding salt, the weight ratio of anionic surfactant to cationic polymer is between 0.5:1 and 4:1, the composition may also have a weight ratio of shielding salt to cationic polymer of between 0.3:1 and 3:1.

US20190390142 A1 relates to fabric care compositions that include a graft copolymer, which may include (a) a polyalkylene oxide, such as polyethylene oxide (PEG); (b) N-vinylpyrrolidone (VP); and (c) a vinyl ester, such as vinyl acetate. Methods and uses relating to such compositions and/or graft copolymers.

### SUMMARY OF THE INVENTION

The present invention relates to a laundry detergent composition comprising a surfactant system and dye transfer inhibition (DTI) polymer, wherein the surfactant system comprises: a branched nonionic surfactant, and wherein the dye transfer inhibition polymer is a graft copolymer, the graft copolymer comprising: polyalkylene oxide which has a number average molecular weight of from 1000 to 20,000 Daltons and is based on ethylene oxide, propylene oxide, or butylene oxide; N-vinylpyrrolidone; and vinyl ester derived from a saturated monocarboxylic acid containing from 1 to 6 carbon atoms and/or a methyl or ethyl ester of acrylic or methacrylic acid; wherein the weight ratio of (a):(b) is from 1:0.1 to 1:2; and wherein the amount, by weight, of (a) is greater than the amount of (c); wherein the branched nonionic surfactant selected from:

a) R1-CH(R2)-O—(PO)x(EO)y(PO)z-H Formula I:

wherein in Formula I: R1 is a C4 to C14 alkyl chain, preferably C4 to C8, more preferably C6; R2 is a C1 to C7 alkyl chain, preferably a C1 to C5, more preferably C3 alkyl chain; x is from 0 to 10, preferably from 0 to 5, more preferably from 0 to 3; y is from 5 to 20, preferably from 6 to 15, more preferably from 7 to 12; z is from 0 to 20, preferably from 0 to 5, more preferably from 0 to 3; EO stands for ethoxylation and PO stands for propoxylation;

b) R1-CH(R2)CH2-O—(PO)x(EO)y(PO)z-H Formula II:

wherein in formula II: R1 is a C3 to C13 alkyl chain, preferably C3 to C7, more preferably C5; R2 is a C1 to C7 alkyl chain, preferably a C1 to C5, more preferably C3 alkyl chain; x is from 0 to 10, preferably from 0 to 5, more preferably from 0 to 3; y is from 5 to 20, preferably from 6 to 15, more preferably from 7 to 12; z is from 0 to 20, preferably from 0 to 5, more preferably from 0 to 3; EO stands for ethoxylation and PO stands for propoxylation.

The present invention further relates to the use of a laundry detergent composition comprising a combination of at least one branched nonionic surfactant and a dye transfer inhibiting polymer for improving the colour protection during laundering, preferably reducing dye redeposition during laundering.

### DETAILED DESCRIPTION OF THE INVENTION

The detergent compositions of the present invention have been found to result in reduced dye fading during laundering.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

All measurements are performed at 25° C. unless otherwise specified.

As used herein, the articles including “a” and “an” when used in a claim, are understood to mean one or more of what is claimed or described.

Laundry Detergent Composition:

The laundry detergent composition can be in any suitable form, such as liquid, paste, granular, solid, powder, or in conjunction with a carrier such as a substrate. Preferred laundry detergent compositions are either liquid or granular, with liquid being most preferred.

As used herein, “liquid detergent composition” refers to liquid detergent composition which is fluid, and preferably capable of wetting and cleaning a fabric, e.g., clothing in a domestic washing machine. As used herein, “laundry detergent composition” refers to compositions suitable for washing clothes. The composition can include solids or gases in suitably subdivided form, but the overall composition excludes product forms which are non-fluid overall, such as tablets or granules. The liquid laundry detergent composition preferably has a density in the range from 0.9 to 1.3 grams per cubic centimetre, more specifically from 1.00 to 1.10 grams per cubic centimetre, excluding any solid additives but including any bubbles, if present.

The composition can be an aqueous liquid laundry detergent composition. For such aqueous liquid laundry detergent compositions, the water content can be present at a level of from 5.0% to 95%, preferably from 25% to 90%, more preferably from 50% to 85% by weight of the liquid detergent composition.

The pH range of the detergent composition is from 6.0 to 8.9, preferably from pH 7 to 8.8.

The detergent composition can also be encapsulated in a water-soluble film, to form a unit dose article. Such unit dose articles comprise a detergent composition of the present invention, wherein the detergent composition comprises less than 20%, preferably less than 15%, more preferably less than 10% by weight of water, and the detergent composition is enclosed in a water-soluble or dispersible film. Such unit-dose articles can be formed using any means known in the art. Suitable unit-dose articles can comprise one compartment, wherein the compartment comprises the liquid laundry detergent composition. Alternatively, the unit-dose articles can be multi-compartment unit-dose articles, wherein at least one compartment comprises the liquid laundry detergent composition.

Dye Transfer Inhibiting Polymers:

The detergent composition comprises one or more dye transfer inhibiting polymer. The dye transfer inhibiting polymer comprises a graft copolymer. The graft copolymer can be present at a level of from 0.05% to 15%, or from 0.1% to 3.0%, and or from 0.2% to 1.0%, by weight of the detergent composition.

Dye transfer inhibiting polymers are known in the art for reducing or preventing dye-transfer during the laundering process. However, it has been found that during laundering, many fabric-dyes partition between the fabric and wash-liquor, and the sequestering of dyes in the wash liquor using DTI polymers has been found to increase dye removal from fabrics, leading to increased dye-fading.

The dye transfer inhibition polymer of use herein is a graft copolymer, the graft copolymer comprising: (a) polyalkylene oxide which has a number average molecular weight of from 1000 to 20,000 Daltons and is based on ethylene oxide, propylene oxide, or butylene oxide, (b) N-vinylpyrrolidone, and (c) vinyl ester derived from a saturated monocarboxylic acid containing from 1 to 6 carbon atoms, wherein the weight ratio of (a):(b) is from 1:0.1 to 1:2, preferably from 1:0.3 to 1:1, and wherein the amount, by weight, of (a) is greater than the amount of (c).

The weight ratio of (a):(c) is from 1.0:0.1 to 1.0:0.99, or from 1.0:0.3 to 1.0:0.9. When the ratio of polyalkylene oxide to N-vinylpyrrolidone is too low, the polymer may form negative interactions with other composition ingredients and/or may lead to negative feel on fabrics, as well as reduced cleaning efficacy.

The weight ratio of (b):(c) can be from 1.0:0.1 to 1.0:5.0, or to 1.0:4.0. Without wishing to be bound by theory, a ratio of N-vinylpyrrolidone-to-vinyl ester that is too high may lead to higher deposition on fabric causing the treated fabric to have a negative feel. Additionally, negative interactions with ingredients such as brighteners may occur.

The amount, by weight of the polymer, of (a) is greater than the amount of (c). The polymer may comprise at least 50% by weight, preferably at least 60% by weight, more preferably at least 75% by weight of (a) polyalkylene oxide. Without wishing to be bound by theory, it is believed that relatively high levels of component (c) (e.g., vinyl acetate), particularly in relation to component (a), may result in decreased performance of dye transfer inhibition and/or relatively greater hydrophobicity, which can lead to formulation and/or stability challenges.

The order of the addition of monomers (b) and (c) in the graft polymerization is immaterial.

The graft copolymer comprises and/or is obtainable by grafting (a) a polyalkylene oxide which has a number average molecular weight of from 1000 to 20000 Da, or to 15000, or to 12000 Da, or to 10000 Da and is based on ethylene oxide, propylene oxide, or butylene oxide, preferably based on ethylene oxide, with (b) N-vinylpyrrolidone, and further with (c) a vinyl ester derived from a saturated monocarboxylic acid containing from 1 to 6 carbon atoms, preferably a vinyl ester that is vinyl acetate or a derivative thereof.

Suitable polyalkylene oxides may be based on homopolymers or copolymers, with homopolymers being preferred. Suitable polyalkylene oxides may be based on homopolymers of ethylene oxide or ethylene oxide copolymers having an ethylene oxide content of from 40 mol % to 99 mol %. Suitable comonomers for such copolymers may include propylene oxide, n-butylene oxide, and/or isobutylene oxide. Suitable copolymers may include copolymers of ethylene oxide and propylene oxide, copolymers of ethylene oxide and butylene oxide, and/or copolymers of ethylene oxide, propylene oxide, and at least one butylene oxide. The copolymers may include an ethylene oxide content of from 40 to 99 mol %, a propylene oxide content of from 1.0 to 60 mol %, and a butylene oxide content of from 1.0 to 30 mol %. The graft base may be linear (straight-chain) or branched, for example a branched homopolymer and/or a branched copolymer.

Branched copolymers may be prepared by addition of ethylene oxide with or without propylene oxides and/or butylene oxides onto polyhydric low molecular weight alcohols, for example trimethylol propane, pentoses, or hexoses.

The alkylene oxide unit may be randomly distributed in the polymer or be present therein as blocks.

The polyalkylene oxides of component (a) may be the corresponding polyalkylene glycols in free form, that is, with OH end groups, or they may be capped at one or both end groups. Suitable end groups may be, for example, C1-C25-alkyl, phenyl, and C1-C14-alkylphenyl groups. The end group may be a C1-alkyl (e.g., methyl) group. Suitable materials for the graft base may include PEG 300, PEG 1000, PEG 2000, PEG 4000, PEG 6000, PEG 8000, PEG 10000, PEG 12000, and/or PEG 20000, which are polyethylene glycols, and/or MPEG 2000, MPEG 4000, MPEG 6000, MPEG 8000 and MEG 10000 which are monomethoxypolyethylene glycols that are commercially available from BASF under the tradename PLURIOL.

Without wishing to be bound by theory, it is believed that if the molecular weight of component (a) (e.g., polyethylene glycol), is relatively low, there may be a performance decrease in dye transfer inhibition. Additionally, or alternatively, when the molecular weight is too high, the polymer may not remain suspended in solution and/or may deposit on treated fabrics.

The graft copolymers of the present disclosure may be characterized by relatively low degree of branching (i.e., degree of grafting). In the graft copolymers of the present disclosure, the average number of grafting sites may be less than or equal to 1.0, or less than or equal to 0.8, or less than or equal to 0.6, or less than or equal to 0.5, or less than or equal to 0.4, per 50 alkylene oxide groups, e.g., ethylene oxide groups. The graft copolymers may comprise, on average, based on the reaction mixture obtained, at least 0.05, or at least 0.1, graft site per 50 alkylene oxide groups, e.g., ethylene oxide groups. The degree of branching may be determined, for example, by means of ¹³C NMR spectroscopy from the integrals of the signals of the graft sites and the —CH₂-groups of the polyalkylene oxide.

The number of grafting sites may be adjusted by manipulating the temperature and/or the feed rate of the monomers. For example, the polymerization may be carried out in such a way that an excess of component (a) and the formed graft copolymer is constantly present in the reactor. For example, the quantitative molar ratio of component (a) and polymer to ungrafted monomer (and initiator, if any) is generally greater than or equal to 10:1, or to 15:1, or to 20:1.

The polyalkylene oxides is grafted with N-vinylpyrrolidone as the monomer of component (b). Without wishing to be bound by theory, it is believed that the presence of the N-vinylpyrrolidone (“VP”) monomer in the graft copolymers according to the present disclosure provides water-solubility and good film-forming properties compared to otherwise-similar polymers that do not contain the N-vinylpyrrolidone monomer. The vinyl pyrrolidone repeat unit has amphiphilic character with a polar amide group that can form a dipole, and a non-polar portion with the methylene groups in the backbone and the ring, making it hydrophobic. When the vinyl pyrrolidone content is too high, there may be negative effects on fabric softness and material cost is high with high vinyl pyrrolidone content.

The polyalkylene oxides are grafted with a vinyl ester as the monomer of component (c). The vinyl ester may be derived from a saturated monocarboxylic acid, which may contain 1 to 6 carbon atoms, or from 1 to 3 carbon atoms, or from 1 to 2 carbon atoms, or 1 carbon atom. Suitable vinyl esters may be selected from the group consisting of vinyl formate, vinyl acetate, vinyl propionate, vinyl butyrate, vinyl valerate, vinyl iso-valerate, vinyl caproate, or mixtures thereof. Preferred monomers of component (c) include those selected from the group consisting of vinyl acetate, vinyl propionate, or mixtures thereof, optionally vinyl acetate.

Conventionally, molecular weights are expressed by their “K-values,” which are derived from relative viscosity measurements. The graft copolymers may have a K value of from 5.0 to 200, optionally from 5.0 to 50, determined according to H. Fikentscher in 2% strength by weight solution in dimethylformamide at 25 C.

The graft copolymers of the present disclosure may be characterized by a relatively narrow molar mass distribution. For example, the graft copolymers may be characterized by a polydispersity M_{w}/Mₙ of less than or equal to 3.0, or less than or equal to 2.5, or less than or equal to 2.3. The polydispersity of the graft copolymers may be from 1.5 to 2.2. The polydispersity may be determined by gel permeation chromatography using organic solvent such as hexafluoroisopropanol (HFIP) with multi-angle laser light scattering detection.

The graft copolymers may be prepared by grafting the suitable polyalkylene oxides of component (a) with the monomers of component (b) in the presence of free radical initiators and/or by the action of high-energy radiation, which may include the action of high-energy electrons. This may be done, for example, by dissolving the polyalkylene oxide in at least one monomer of group (b), adding a polymerization initiator and polymerizing the mixture to completion. The graft polymerization may also be carried out semicontinuously by first introducing a portion, for example 10%, of the mixture of polyalkylene oxide to be polymerized, at least one monomer of group (b) and/or (c) and initiator, heating to polymerization temperature and, after the polymerization has started, adding the remainder of the mixture to be polymerized at a rate commensurate with the rate of polymerization. The graft copolymers may also be obtained by introducing the polyalkylene oxides of group (a) into a reactor, heating to the polymerization temperature, and adding at least one monomer of group (b) and/or (c) and polymerization initiator, either all at once, a little at a time, or uninterruptedly, optionally uninterruptedly, and polymerizing.

In the preparation of the graft copolymers, the order in which the monomers (b) and (c) are grafted onto component (a) may be immaterial and/or freely chooseable. For example, first N-vinylpyrrolidone may be grafted onto component (a), and then a monomer (c) or a mixture of monomers of group (c). It is also possible to first graft the monomers of group (c) and then N-vinylpyrrolidone onto the graft base (a). It may be that a monomer mixture of (b) and (c) are grafted onto graft base (a) in one step. The graft copolymer may be prepared by providing graft base (a) and then first grafting N-vinylpyrrolidone and then vinyl acetate onto the graft base.

Any suitable polymerization initiator(s) may be used, which may include organic peroxides such as diacetyl peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxodicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl peracetate, di-tert-amyl peroxide, tert-butyl hydroperoxide, mixtures thereof, redox initiators, and/or azo starters. The choice of initiator may be related to the choice of polymerization temperature.

The graft polymerization may take place at from 50° C. to 200° C., or from 70° C. to 140° C. The graft polymerization may typically be carried out under atmospheric pressure, but may also be carried out under reduced or superatmospheric pressure.

The graft polymerization may be carried out in a solvent. Suitable solvents may include: monohydric alcohols, such as ethanol, propanols, and/or butanols; polyhydric alcohols, such as ethylene glycol and/or propylene glycol; alkylene glycol ethers, such as ethylene glycol monomethyl and -ethyl ether and/or propylene glycol monomethyl and -ethyl ether; polyalkylene glycols, such as di- or tri-ethylene glycol and/or di- or tri-propylene glycol; polyalkylene glycol monoethers, such as poly(C2-C3-alkylene)glycol mono (C1-C16-alkyl)ethers having 3-20 alkylene glycol units; carboxylic esters, such as ethyl acetate and ethyl propionate; aliphatic ketones, such as acetone and/or cyclohexanone; cyclic ethers, such as tetrahydrofuran and/or dioxane; or mixtures thereof.

The graft polymerization may also be carried out in water as solvent. In such cases, the first step may be to introduce a solution which, depending on the amount of added monomers of component (b), is more or less soluble in water. To transfer water-insoluble products that can form during the polymerization into solution, it is possible, for example, to add organic solvents, for example monohydric alcohols having 1 to 3 carbon atoms, acetone, and/or dimethylformamide. In a graft polymerization process in water, it is also possible to transfer the water-insoluble graft copolymers into a finely divided dispersion by adding customary emulsifiers or protective colloids, for example polyvinyl alcohol. The emulsifiers used may be ionic or nonionic surfactants whose HLB value is from 3.0 to 13. HLB value is determined according to the method described in the paper by W. C. Griffin in J. Soc. Cosmet. Chem. 5 (1954), 249.

The amount of surfactant used in the graft polymerization process may be from 0.1 to 5.0% by weight of the graft copolymer. If water is used as the solvent, solutions or dispersions of graft copolymers may be obtained. If solutions of graft copolymers are prepared in an organic solvent or in mixtures of an organic solvent and water, the amount of organic solvent or solvent mixture used per 100 parts by weight of the graft copolymer may be from 5 to 200, optionally from 10 to 100, parts by weight.

After the graft polymerization, the graft copolymer may optionally be subjected to a partial hydrolysis. In the graft copolymer, from 1.0 mol % to 60 mol %, preferably from 20 mol % to 60 mol %, more preferably from 30 mol % to 50 mol % of the grafted-on monomers of component (c) are hydrolyzed. For instance, the hydrolysis of graft copolymers prepared using vinyl acetate or vinyl propionate as component (c) gives graft copolymers containing vinyl alcohol units. The hydrolysis may be carried out, for example, by adding a base, such as sodium hydroxide solution or potassium hydroxide solution, or alternatively by adding acids and if necessary, heating the mixture. Without wishing to be bound by theory, it is believed that increasing the level of hydrolysis of component (c) increases the relative hydrophilicity of the graft copolymer, which in turn is believed to result in better suspension of the captured dyes.

Surfactant System

The laundry composition comprises a surfactant system at a level of from 2.5% to 60%, preferably from 5.0% to 25%, more preferably from 7.0% to 15% by weight of the composition.

Suitable surfactants as used herein means surfactants or mixtures of surfactants that provide cleaning, stain removing, or laundering benefit to soiled material. Suitable detersive surfactants can be: anionic surfactant, nonionic surfactant, zwitterionic surfactant, and combinations thereof.

The surfactant system comprises branched nonionic surfactant. The surfactant system can further comprise a surfactant selected from the group consisting of: anionic surfactant, amphoteric surfactant, and mixtures thereof. As such, the surfactant system can comprise a combination of anionic and nonionic surfactant, more preferably a combination of anionic surfactant, nonionic surfactant, and amphoteric surfactant.

Preferably surfactants comprising saturated alkyl chains are used.

Branched Nonionic Surfactant

The surfactant system can comprise branched nonionic surfactant at a level of from 0.1% to 12%, preferably from 0.5% to 10%, more preferably from 1.0% to 3.0% by weight of the composition.

Suitable branched nonionic surfactants can be derived from primary or secondary alcohols. The branched nonionic surfactant is selected from:

a) R1-CH(R2)-(PO)ₓ(EO)_{y}(PO)_{z}—H Formula I:

In Formula I, R1 is a C4 to C14 alkyl chain, preferably C4 to C8, more preferably C6; R2 is a C1 to C7 alkyl chain, preferably a C1 to C5, more preferably C3 alkyl chain; x is from 0 to 10, preferably from 0 to 5, more preferably from 0 to 3; y is from 5 to 20, preferably from 6 to 15, more preferably from 7 to 12; and z is from 0 to 20, preferably from 0 to 5, more preferably from 0 to 3, EO stands for ethoxylation and PO stands for propoxylation;

b) R1-CH(R2)CH2-(PO)ₓ(EO)_{y}(PO)_{z}—H Formula II:

In formula II: R1 is a C3 to C13 alkyl chain, preferably C3 to C7, more preferably C5; R2 is a C1 to C7 alkyl chain, preferably a C1 to C5, more preferably C3 alkyl chain; x is from 0 to 10, preferably from 0 to 5, more preferably from 0 to 3; y is from 5 to 20, preferably from 6 to 15, more preferably from 7 to 12; and z is from 0 to 20, preferably from 0 to 5, more preferably from 0 to 3, EO stands for ethoxylation and PO stands for propoxylation.

Preferred branched non-ionic ethoxylates according to formula I are those available under the tradenames Tergitol® 15-S, with an alkoxylation degree of from 3 to 40. For instance Tergitol® 15-S-20 which has an average degree of alkoxylation of 20. Other suitable commercially available material according to formula I are the ones available under the tradename Softanol® M and EP series.

Preferred branched nonionic surfactants according to formula II are the Guerbet C10 alcohol ethoxylates with 7 or 8 EO, such as Ethylan® 1007 & 1008, and the Guerbet C10 alcohol alkoxylated nonionic surfactants (which are ethoxylated and/or propoxylated) such as the commercially available Lutensol® XL series (XL50, XL70. etc). Other exemplary alkoxylated branched nonionic surfactants include those available under the trade names: Lutensol® XP30, Lutensol® XP-50, and Lutensol® XP-80 available from BASF Corporation. In general, Lutensol® XP-30 can be considered to have 3 repeating ethoxy groups, Lutensol® XP-50 can be considered to have 5 repeating ethoxy groups, and Lutensol® XP-70 can be considered to have 7 repeating ethoxy groups. Other suitable branched nonionic surfactants include oxo branched nonionic surfactants such as the Lutensol® ON 50 (5 EO) and Lutensol® ON70 (7 EO). Other suitable branched nonionic surfactants include Plurafac® SLF 170 (3PO, 12EO, 15PO). Also suitable are: the ethoxylated fatty alcohols originating from the Fischer & Tropsch reaction comprising up to 50% branching (40% methyl (mono or bi), 10% cyclohexyl) such as those produced from the Safol® alcohols from Sasol; ethoxylated fatty alcohols originating from the oxo reaction wherein at least 50% by weight of the alcohol is C2 isomer (methyl to pentyl) such as those produced from the Isalchem® alcohols or Lial® alcohols from Sasol.

Further Nonionic Surfactant

The liquid detergent composition can comprise further nonionic surfactant. The level of further nonionic surfactant in the liquid detergent composition can be present at a level of less than 15 wt %, preferably less than 7.0 wt %, more preferably less than 5.0 wt %, and even more preferably less than 3.0 wt %. Most preferably, the composition is free of further nonionic surfactant.

Suitable nonionic surfactants include, but are not limited to linear C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e.g., amine oxides and phosphine oxides) can be used in the present compositions. An extensive disclosure of these types of surfactants is found in U.S. Pat. No. 3,929,678.

Alkylpolysaccharides such as disclosed in U.S. Pat. No. 4,565,647 are also useful nonionic surfactants in the compositions of the invention.

Also suitable are alkyl polyglucoside surfactants.

Further nonionic surfactants of use include those of the formula R₁(OC₂H₄)ₙOH, wherein R₁ is a linear C10-C16 alkyl group or a C8-C12 alkyl phenyl group, and n is from preferably 3 to 80. In some embodiments, the nonionic surfactants may be condensation products of linear C12-C15 alcohols with from 5 to 20 moles of ethylene oxide per mole of alcohol, e.g., C12-C13 alcohol condensed with 6.5 moles of ethylene oxide per mole of alcohol

Anionic Surfactant

The surfactant system can comprise anionic surfactant at a level of from 1.4% to 52%, preferably from 4.4% to 20%, more preferably from 5.9% to 11.5% of the liquid laundry detergent composition.

The surfactant system can further comprise an anionic surfactant, preferably selected from the group consisting of: sulphonate surfactant, sulphate surfactant, and mixtures thereof, more preferably wherein the anionic surfactant comprises sulphonate surfactant and sulphate surfactant. Suitable anionic surfactants also include fatty acids and their salts, which are typically added as builders. However, by nature, every anionic surfactant known in the art of detergent compositions may be used, such as disclosed in “Surfactant Science Series”, Vol. 7, edited by W. M. Linfield, Marcel Dekker. However, the composition preferably comprises at least a sulphonic acid surfactant, such as a linear alkyl benzene sulphonic acid, but water-soluble salt forms may also be used. Alkyl sulphates, or mixtures thereof, are also preferred. A combination of linear alkyl benzene sulphonate and alkyl sulphate surfactant is particularly preferred, especially for improving stain removal.

Anionic sulphonate or sulphonic acid surfactants suitable for use herein include the acid and salt forms of alkylbenzene sulphonates, alkyl ester sulphonates, alkane sulphonates, alkyl sulphonated polycarboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates, C6-C22 primary or secondary alkane sulphonates, C5-C20 sulphonated polycarboxylic acids, and any mixtures thereof, but preferably C11-C13 alkylbenzene sulphonates. The aforementioned surfactants can vary widely in their 2-phenyl isomer content.

Anionic sulphate salts suitable for use in the compositions of the invention include the primary and secondary alkyl sulphates, having a linear

or branched alkyl or alkenyl moiety having from 9 to 22 carbon atoms or more preferably 12 to 18 carbon atoms. Also useful are beta-branched alkyl sulphate surfactants or mixtures of commercially available materials, having a weight average (of the surfactant or the mixture) branching degree of at least 50%.

Mid-chain branched alkyl sulphates or sulphonates are also suitable anionic surfactants for use in the compositions of the invention. Preferred are the C5-C22, preferably C10-C20 mid-chain branched alkyl primary sulphates. When mixtures are used, a suitable average total number of carbon atoms for the alkyl moieties is preferably within the range of from greater than 14.5 to 17.5. Preferred mono-methyl-branched primary alkyl sulphates are selected from the group consisting of the 3-methyl to 13-methyl pentadecanol sulphates, the corresponding hexadecanol sulphates, and mixtures thereof. Dimethyl derivatives or other biodegradable alkyl sulphates having light branching can similarly be used.

When used, the alkyl alkoxylated sulphate surfactant can be a blend of one or more alkyl ethoxylated sulphates. Suitable alkyl alkoxylated sulphates include C10-C18 alkyl ethoxylated sulphates, more preferably C12-C15 alkyl ethoxylated sulphates. The anionic surfactant can comprise alkyl sulphate surfactant, wherein the alkyl sulphate surfactant has an average degree of ethoxylation of from 0.5 to 8.0, preferably from 1.0 to 5.0, more preferably from 2.0 to 3.5.

Alternatively, the anionic surfactant can comprise alkyl sulphate surfactant, wherein the alkyl sulphate surfactant has a low degree of ethoxylation, having an average degree of ethoxylation of less than 0.5, preferably less than 0.1, and more preferably is free of ethoxylation. Preferred low ethoxylation alkyl sulphate surfactants do not comprise any further alkoxylation. Preferred low ethoxylation alkyl sulphate surfactants comprise branched alkyl sulphate surfactant. The branched alkyl sulphate surfactant can comprise at least 20%, preferably from 60% to 100%, more preferably from 80% to 90% by weight of the alkyl chains of the branched alkyl sulphate surfactant of 2-branched alkyl chains. Such branched alkyl sulphates with 2-branched alkyl chains can also be described as 2-alkyl alkanol sulphates, or 2-alkyl alkyl sulphates. The branched alkyl sulphates can be neutralized by sodium, potassium, magnesium, lithium, calcium, ammonium, or any suitable amines, such as, but not limited to monoethanolamine, triethanolamine and monoisopropanolamine, or by mixtures of any of the neutralizing metals or amines. Suitable branched alkyl sulphate surfactants can comprise alkyl chains comprising from 10 to 18 carbon atoms (C10 to C18) or from 12 to 15 carbon atoms (C12 to C15), with 13 to 15 carbon atoms (C13 to C15) being most preferred. The branched alkyl sulphate surfactant can be produced using processes which comprise a hydroformylation reaction in order to provide the desired levels of 2-branching. Particularly preferred branched alkyl sulphate surfactants comprise 2-branching, wherein the 2-branching comprises from 20% to 80%, preferably from 30% to 65%, more preferably from 40% to 50% by weight of the 2-branching of methyl branching, ethyl branching, and mixtures thereof.

Suitable low ethoxylated branched alkyl sulphate surfactants can be derived from alkyl alcohols such as Lial® 145, Isalchem® 145, both supplied by Sasol, optionally blending with other alkyl alcohols in order to achieve the desired branching distributions.

Lower levels of dye removal from fabrics during laundering can be achieved while maintaining cleaning performance, when laundering the fabrics at temperatures of 30° C. or below when the fabrics are washed using compositions of the present invention comprising such low ethoxylated alkyl sulphate surfactants, especially when the low ethoxylated alkyl sulphate surfactants comprise the 2-branching as described above.

Processes to make such alkyl ether sulphate anionic surfactants may result in trace residual amounts of 1,4-dioxane by-product being present. The amount of 1,4-dioxane by-product within alkoxylated especially ethoxylated alkyl sulphates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. An alternative is to use alkyl sulphate anionic surfactants which comprise only low levels of ethoxylation, or even being free of ethoxylation. As such, the alkyl Miguel

Other suitable anionic surfactants for use herein include fatty methyl ester sulphonates and/or alkyl polyalkoxylated carboxylates, for example, alkyl ethoxylated carboxylates (AEC).

The anionic surfactants are typically present in the form of their salts with alkanolamines or alkali metals such as sodium and potassium.

For improved stability and grease cleaning, the liquid detergent composition can comprise a combination of linear alkyl benzene sulphonate surfactant and alkyl sulphate surfactant, preferably such that the ratio of linear alkyl benzene sulphonate surfactant to alkyl alkoxylated sulphate surfactant is from 15:1 to 0.1:1, preferably from 10:1 to 0.3:1, more preferably from 5:1 to 1:1.

Amphoteric and/or Zwitterionic Surfactant

The surfactant system can comprise amphoteric and/or zwitterionic surfactant at a level of from 0.1% to 2.0%, preferably from 0.1% to 1.0%, more preferably from 0.1% to 0.5% by weight of the liquid laundry detergent composition.

Suitable amphoteric surfactants include amine oxide surfactants. Amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide (lauryl dimethylamine oxide), commercially available from Albright & Wilson, C₁₂-C₁₄ amine oxides commercially available under the trade name Genaminox® LA from Clariant or AROMOX® DMC from AKZO Nobel.

Suitable amphoteric or zwitterionic detersive surfactants include those which are known for use in hair care or other personal care cleansing. Non-limiting examples of suitable zwitterionic or amphoteric surfactants are described in U.S. Pat. Nos. 5,104,646, 5,106,609. Suitable amphoteric detersive surfactants include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulphonate, sulphate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

Optional Ingredients

The detergent composition may additionally comprise one or more of the following optional ingredients: external structurant or thickener, enzymes, enzyme stabilizers, cleaning polymers, bleaching systems, optical brighteners, hueing dyes, particulate material, perfume and other odour control agents, hydrotropes, suds suppressors, fabric care benefit agents, pH adjusting agents, further dye transfer inhibiting polymer, dye fixative polymers, preservatives, non-fabric substantive dyes and mixtures thereof. In more preferred embodiments, the laundry detergent composition does not comprise a bleach.

External structurant or thickener: Preferred external structurants and thickeners are those that do not rely on charge—charge interactions for providing a structuring benefit. As such, particularly preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

Suitable polymeric structurants include naturally derived and/or synthetic polymeric structurants.

Examples of naturally derived polymeric structurants of use in the present invention include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO 2009/101545 A1. Suitable polysaccharide derivatives include: pectine, alginate, arabinogalactan (gum Arabic), carrageenan, gellan gum, xanthan gum, guar gum and mixtures thereof.

Examples of synthetic polymeric structurants or thickeners of use in the present invention include: polycarboxylates, hydrophobically modified ethoxylated urethanes (HEUr), hydrophobically modified non-ionic polyols and mixtures thereof.

Preferably, the aqueous liquid detergent composition has a viscosity of 50 to 5,000, preferably 75 to 1,000, more preferably 100 to 500 mPa·s, when measured at a shear rate of 100 s-1, at a temperature of 20° C. For improved phase stability, and also improved stability of suspended ingredients, the aqueous liquid detergent composition has a viscosity of 50 to 250,000, preferably 5,000 to 125,000, more preferably 10,000 to 35,000 mPa·s, when measured at a shear rate of 0.05 s-1, at a temperature of 20° C.

Cleaning polymers: The detergent composition preferably comprises a cleaning polymer. Such cleaning polymers are believed to at least partially lift the stain from the textile fibres and enable the enzyme system to more effectively break up the complexes comprising mannan and other polysaccharide. Suitable cleaning polymers provide for broad-range soil cleaning of surfaces and fabrics and/or suspension of the soils. Non-limiting examples of suitable cleaning polymers include: amphiphilic alkoxylated grease cleaning polymers; clay soil cleaning polymers; soil release polymers; and soil suspending polymers. A preferred cleaning polymer is obtainable by free-radical copolymerization of at least one compound of formula (I),

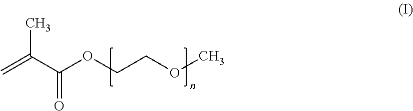

in which n is equal to or greater than 3 for a number,

with at least one compound of formula (II),

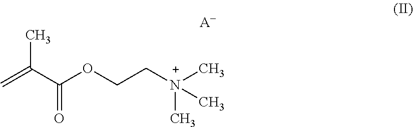

in which A⁻ represents an anion, in particular selected from halides such as fluoride, chloride, bromide, iodide, sulphate, hydrogen sulphate, alkyl sulphate such as methyl sulphate, and mixtures thereof. Such polymers are further described in EP3196283A1.

For similar reasons, polyester based soil release polymers, such as SRA300, supplied by Clariant are also particularly preferred.

Other useful cleaning polymers are described in US20090124528A1. The detergent composition may comprise amphiphilic alkoxylated grease cleaning polymers, which may have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkyleneimines, for example. Such compounds may comprise, but are not limited to, ethoxylated polyethyleneimine, ethoxylated hexamethylene diamine, and sulphated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The alkoxylated polyalkyleneimines may have an inner polyethylene oxide block and an outer polypropylene oxide block. The detergent compositions may comprise from 0.1% to 10%, preferably, from 0.1% to 8.0%, more preferably from 0.1% to 2.0%, by weight of the detergent composition, of the cleaning polymer.

Further dye transfer inhibiting polymers: The detergent composition can comprise one or more further dye transfer inhibiting polymer. However, preferred compositions do not comprise such further dye transfer inhibiting polymers. It has been found that during laundering, many fabric-dyes partition between the fabric and wash-liquor. As such, the sequestering of dyes in the wash liquor using DTI polymers has been found to increase dye removal from fabrics, and hence increase dye-fading.

When used, suitable further dye transfer inhibiting can be selected from the group consisting of polyvinylpyrrolidone homopolymers (PVP), polyvinylimidazole (PVI), polyvinyl pyrrolidone/polyvinyl imidazole copolymers (PVP/PVI), polyvinyl pyridine-N-oxide (PVNO), poly(vinylpyrrolidone) co-poly(vinylpyridine-N-oxide) (PVP/PVNO) polymers, poly-N-carboxymethyl-4-vinylpyridiumchloride, poly(2-hydroxypropyldimethylammonium chloride), and mixtures thereof, preferably polyvinylpyrrolidone (PVP), polyvinylimidazole (PVI), copolymers of vinylpyrrolidone and vinylimidazole (PVP/PVI), and mixtures thereof.

Polyvinylpyrrolidone (“PVP”) has an amphiphilic character with a highly polar amide group conferring hydrophilic and polar attracting properties, and also has a polar methylene and methane groups, in the backbone and/or the ring, conferring hydrophobic properties. The rings may also provide planar alignment with the aromatic rings, in the dye molecules. PVP is readily soluble in aqueous and organic solvent systems. PVP is commercially available in either powder or aqueous solutions in several viscosity grades. The compositions of the present invention preferably utilize a copolymer of N-vinylpyrrolidone and N-vinylimidazole (also abbreviated herein as “PVPVI”). It has been found that the further addition of copolymers of N-vinylpyrrolidone and N-vinylimidazole can provide excellent dye transfer inhibiting performance. The copolymers of N-vinylpyrrolidone and N-vinylimidazole can have a molar ratio of N-vinylimidazole to N-vinylpyrrolidone from 1:1 to 0.2:1, more preferably from 0.8:1 to 0.3:1, most preferably from 0.6:1 to 0.4:1. The copolymer of N-vinylpyrrolidone and N-vinylimidazole can be either linear or branched. Particularly suitable polyvinylpyrrolidones (PVP), polyvinylimidazoles (PVI), and copolymers of vinylpyrrolidone and vinylimidazole (PVP/PVI), can have a weight average molecular weight of from 5,000 Da to 1,000,000 Da, preferably from 5,000 Da to 50,000 Da, more preferably from 10,000 Da to 20,000 Da. The number average molecular weight range is determined by light scattering as described in Barth J. H. G. and Mays J. W. Chemical Analysis Vol 1 13. “Modern Methods of Polymer Characterization.” Copolymers of poly (N-vinyl-2-pyrollidone) and poly (N-vinyl-imidazole) are commercially available from a number of sources including BASF. A preferred DTI is commercially available under the tradename Sokalan® HP 56 K from BASF (BASF SE, Germany).

Organic builder and/or chelant: The laundry detergent composition can comprise from 0.6% to 10%, preferably from 2.0 to 7.0% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (EDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulphonates such as Tiron™ and mixtures thereof.

Enzymes: Suitable enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, lipase, cutinase and/or cellulase in conjunction with amylase. Detersive enzymes are described in greater detail in U.S. Pat. No. 6,579,839.

Enzyme stabiliser: Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Hueing dyes: The detergent composition may comprise fabric hueing agent (sometimes referred to as shading, bluing, or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and combinations thereof.

Suitable polymeric dyes include dyes selected from the group consisting of polymers containing covalently bound (sometimes referred to as conjugated) chromogens, (also known as dye-polymer conjugates), for example polymers with chromogen monomers co-polymerized into the backbone of the polymer and mixtures thereof. Preferred polymeric dyes comprise the optionally substituted alkoxylated dyes, such as alkoxylated triphenyl-methane polymeric colourants, alkoxylated carbocyclic and alkoxylated heterocyclic azo colourants including alkoxylated thiophene polymeric colourants, and mixtures thereof, such as the fabric-substantive colorants sold under the name of Liquitint® (Milliken, Spartanburg, S.C., USA).

The amount of adjunct hueing agent present in a laundry care composition of the invention may be from 0.0001 to 0.05 wt % based on the total cleaning composition, preferably from 0.0001 to 0.005 wt %. Based on the wash liquor, the concentration of hueing agent may be from 1 ppb to 5 ppm, preferably from 10 ppb to 500 ppb.

Optical brighteners: The detergent composition may comprise, based on the total detergent composition weight, from 0.005% to 2.0%, preferably 0.01% to 0.1% of a fluorescent agent (optical brightener). Fluorescent agents are well known and many fluorescent agents are available commercially. Usually, these fluorescent agents are supplied and used in the form of their alkali metal salts, for example, the sodium salts. Preferred classes of fluorescent agent are: Di-styryl biphenyl compounds, e.g. Tinopal® CBS-X, Di-amine stilbene di-sulphonic acid compounds, e.g. Tinopal® DMS pure Xtra and Blankophor® HRH, and Pyrazoline compounds, e.g. Blankophor® SN. Preferred fluorescers are: sodium 2-(4-styryl-3-sulphophenyl)-2H-napthol[1,2-d]trazole, disodium 4,4′-bis{[(4-anilino-6-(N methyl-N-2 hydroxyethyl) amino 1,3,5-triazin-2-yl)]amino}stilbene-2-2′ di sulphonate, disodium 4,4′-bis{[(4-anilino-6-morpholino-1,3,5-triazin-2-yl)]amino} stilbene-2-2′ disulphonate, and disodium 4,4′-bis(2-sulphoslyryl)biphenyl.

Hydrotrope: The detergent composition may comprise, based on the total detergent composition weight, from 0 to 30%, preferably from 0.5 to 5%, more preferably from 1.0 to 3.0%, which can prevent liquid crystal formation. The addition of the hydrotrope thus aids the clarity/transparency of the composition. Suitable hydrotropes comprise but are not limited to urea, salts of benzene sulphonate, toluene sulphonate, xylene sulphonate or cumene sulphonate. Preferably, the hydrotrope is selected from the group consisting of propylene glycol, xylene sulphonate, ethanol, and urea to provide optimum performance.

Particles: The composition can also comprise particles, especially when the composition further comprises a structurant or thickener. The composition may comprise, based on the total composition weight, from 0.02% to 10%, preferably from 0.1% to 4.0%, more preferably from 0.25% to 2.5% of particles. Said particles include beads, pearlescent agents, capsules, and mixtures thereof.

Suitable capsules are typically formed by at least partially, preferably fully, surrounding a benefit agent with a wall material. Preferably, the capsule is a perfume capsule, wherein said benefit agent comprises one or more perfume raw materials. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof. Preferably, the capsule wall comprises melamine and/or a polyacrylate based material. The perfume capsule may be coated with a deposition aid, a cationic polymer, a non-ionic polymer, an anionic polymer, or mixtures thereof. Preferably, the perfume capsules have a volume weighted mean particle size from 0.1 microns to 100 microns, preferably from 0.5 microns to 60 microns. Especially where the composition comprises capsules having a shell formed at least partially from formaldehyde, the composition can additionally comprise one or more formaldehyde scavengers.

Process of Making the Laundry Detergent Composition:

The laundry detergent compositions can be made using any suitable process known to the skilled person. Typically, the ingredients are blended together in any suitable order. Preferably, the detersive surfactants are added as part of a concentrated premix, to which are added the other optional ingredients. Preferably, the solvent is added either last, or if an external structurant is added, immediately before the external structurant, with the external structurant being added as the last ingredient.

Method of Laundering Fabrics:

The laundry detergent compositions of the present invention can be used to launder fabrics.

In particular, the laundry detergent composition comprising the branched nonionic surfactant can be used for improving the color protection, preferably color retention, of colored fabrics during laundering.

The laundry detergent compositions of the present invention are particularly useful for preventing the removal of fabric-dyes selected from the group consisting of: reactive dyes, disperse dyes, and mixtures thereof, preferably wherein the fabric dyes are selected from the group consisting of: disperse dyes, reactive dyes, and mixtures thereof, from fabrics during the laundering process.

The compositions of the present invention are particularly effective for reducing the redeposition of dyes from fabrics comprising cotton, especially cotton-comprising fabrics having dyes selected from the group consisting of: reactive dyes, disperse dyes, direct dyes, vat dyes, and mixtures thereof; preferably wherein the reactive dyes are selected from the group consisting of: the reactive dyes are selected from the group consisting of: reactive black 5, reactive red 239, reactive red 195, the direct dyes are selected from the group consisting of: direct black 22, direct red 83, direct red 227, and the vat dyes are selected from the group consisting of: indigo (vat blue 1), sulphur black 1, and mixtures thereof. The compositions of the present invention are particularly useful for reducing the removal of dyes from cotton-comprising fabrics having dyes selected from the group consisting of: reactive dyes, especially reactive dyes selected from the group consisting of: reactive black 5, reactive red 239, and mixtures thereof.

The compositions of the present invention are also effective for reducing the redeposition of dyes from fabrics comprising polyester, especially polyester-comprising fabrics comprising disperse dyes selected from the group consisting of: disperse orange 30, disperse red 167, disperse blue 79, disperse red 60, and mixtures thereof, preferably disperse blue 79.

In such methods and uses, the laundry detergent composition can be diluted to provide a wash liquor having a total surfactant concentration of greater than 100 ppm, preferably from 200 ppm to 2,500 ppm, more preferably from 300 ppm to 1000 ppm. The fabric is then washed in the wash liquor, and preferably rinsed.

### Methods

A) pH Measurement:

The pH is measured, at 25° C., using a Santarius PT-10P pH meter with gel-filled probe (such as the Toledo probe, part number 52 000 100), calibrated according to the instruction manual. The pH is measured in a 10% dilution in demineralised water (i.e. 1 part laundry detergent composition and 9 parts demineralised water).

B) Method of Measuring Viscosity:

The viscosity is measured using an AR 2000 rheometer from TA instruments using a cone and plate geometry with a 40 mm diameter and an angle of 1°. The viscosity at the different shear rates is measured via a logarithmic shear rate sweep from 0.1 s⁻¹ to 1200 s⁻¹ in 3 minutes time at 20° C. Low shear viscosity is measured at a continuous shear rate of 0.05 s⁻¹.

C) Dye Transfer Measurement Method on Treated Fabrics

The “L*C*h color space” and “L*a*b* color space” are three dimensional colorimetric models developed by Hunter Associates Laboratory and recommended by the Commission Internationale d'Eclairage (“CIE”) to measure the color or change in color of a dyed article. The CIE L*a*b* color space (“CIELAB”) has a scale with three-fold axes with the L axis representing the lightness of the color space (L*=0 for black, L*=100 for white), the a* axis representing color space from red to green (a*>0 for red, a*<0 for green) and the b* axis representing color space from yellow to blue (b*>0 for yellow, b*<0 for blue). The L*C*h color space is an approximately uniform scale with a polar color space. The CIE L*C*h color space (“CIELCh”) scale values are determined instrumentally and may also be calculated from the CIELAB scale values. Term definitions and equation derivations are available from Hunter Associates Laboratory, Inc. and from www.hunterlab.com, and are incorporated in their entirety by reference herein.

The amount of dye transfer onto the acceptor fabrics can be described, for example, in terms of the change in L*a*b before and after treatment of the fabric as measured via spectrophotometry (for example, via a Spetro-Guide 45/0 Gloss 6801 color spectrophotometer) and is reported as dE value. As used herein, the dE value includes the vector associated with the distance in the L*a*b space between the initial L*a*b value and the final L*a*b value. Test fabrics are folded in half to double the thickness before measuring. An average of two L*a*b* measures are taken per test fabric, and two fabrics are measured per example.

Relatively higher dE values correspond to a greater color change, indicating that relatively more dye transferred to the fabric in question, and relatively lower dE values correspond to less dye transfer.

### Examples

Examples of graft copolymers include those listed in Table 1:

TABLE 1
Examples of graft copolymers of use herein.

| Graft | Monomer Ratio | | | PEG | | |
|---|---|---|---|---|---|---|
| Copolymer | (by weight) | | | Molecular | | VAc |
| Examples | PEG | VP | VAc | Weight (Da) | K-Value | Hydrolysis |
| 1A | 1.00 | 0.28 | 0.13 | 4000 | 22.9 | <20% |
| 1B | 1.00 | 0.31 | 0.25 | 4000 | 21.6 | <20% |
| 1C | 1.00 | 0.35 | 0.40 | 4000 | 19.7 | <20% |
| 1D | 1.00 | 0.40 | 0.60 | 4000 | 20.1 | <20% |
| 1E | 1.00 | 0.40 | 0.60 | 2000 | 18.3 | <20% |
| 1F | 1.00 | 0.40 | 0.60 | 6000 | 23.5 | <20% |
| 1G | 1.00 | 0.40 | 0.60 | 8000 | 26.3 | <20% |
| 1H | 1.00 | 0.40 | 0.60 | 4000 | 20.6 | 20% |
| 1I | 1.00 | 0.40 | 0.60 | 4000 | 21.0 | 40% |
| 1J | 1.00 | 0.40 | 0.60 | 6000 | 24.4 | 20% |
| 1K | 1.00 | 0.40 | 0.60 | 6000 | 24.5 | 40% |
| 1L | 1.00 | 0.40 | 0.60 | 6000 | 24.4 | 60% |
| 1M | 1.00 | 0.50 | 1.00 | 4000 | 19.2 | <20% |

PEG = poly(ethylene glycol); VP = vinyl pyrrolidone; VAc = vinyl acetate

K-value, in Table 1, is a measure of the relative viscosity of dilute polymer solutions and is a relative measure of the average molecular weight. As the average molecular weight of the polymer increases for a particular polymer, the K-value tends to also increase. The K-value is determined in a 3% by weight NaCl solution at 23° C. and a polymer concentration of 1% polymer according to the method of H. Fikentscher in Cellulosechemie, 1932, 13, 58.

The following methodology was used to evaluate the impact of branched and linear nonionic surfactants on dye-bleeding during laundering.

Glass vials (size 4 ml) were filled with 2 ml of test detergent solutions, as described below, before subsequently inserting into a thermo-shaker (Echotherm® Orbital Shaker) set at the temperature of 40° C. The solutions were kept at this temperature for 15 minutes in order for the temperature to equilibrate.

The colored fabric samples as described below were cut into pieces of 150±1 mg (weighed using an analytical balance). These pieces had an area of circa 2.5×2.5 cm (depending on the fabric used). If needed, additional pieces of the same fabric were added to reach the target weight.

Each textiles piece was folded and then inserted into the vials using a disposable glass stick, so that the fabric was fully covered by the solution, before returning the vial to the thermo-shaker.

The vials were continually shaken (using the medium speed setting) at temperature of 40° C. for 60 minutes.

The vials were then removed from the thermo-shaker and the fabrics removed from the test detergent solutions. The solutions were kept in the dark for the time required to reach room temperature (25° C.).

The dye desorption was quantified as follows:

950 μl of each solution was placed into a semi-micro plastic cuvette and their absorbance spectra recorded using a UV-vis spectrophotometer (Cary UV-Vis Multicell Peltier, supplied by Agilent), measuring absorbance between 300 nm and 900 nm).

To each solution was added 50 μl of a 20 wt % aqueous solution of 2-[4-(2,4,4-trimethylpentan-2-yl)phenoxy]ethanol (Triton X-100, supplied by Sigma Aldrich) and the absorbance spectra between 300 nm and 900 nm was remeasured. The Triton X-100 was added as it was observed that, at the test concentrations used, Triton X-100 strongly reduced the scattering of the tested surfactants in the region overlapping the dye absorption spectra.

A calibration curve of each dye used was obtained using the following procedure:

Firstly, the following reference detergent solution was made:

A 350 ppm aqueous solution of equal weight parts of linear C10-C13 alkylbenzene sulphonic acid (HLAS), linear C12-C15 alkyl ethoxy (3.0) sulphate (AE3.0S), and linear C12-C14 EO7 (Lordac L726, supplied by Sasol) in water of hardness 2.67 mmol CaCO₃ equivalence (CaCl₂ 1.93 mmol, MgCl₂ 0.64 mmol, 15 gpg) was prepared. The pH of the resultant solution was adjusted to 8.0 using ethanolamine.

2.0 ml of the composition was placed in the glass vial with 150 mg of each fabric, and washed using the procedure above, but at a temperature of 92° C. for 15 minutes.

After cooling to room temperature in the dark, 950 μl of the resultant solutions comprising desorbed dye were combined with 50 μl of a 20 wt % aqueous solution of 2-[4-(2,4,4-trimethylpentan-2-yl)phenoxy]ethanol (Triton X-100). The absorbance spectra were measured, as described above, and these solutions were arbitrary fixed as 95% dye desorption. The solutions were diluted in the following media: 95% of the above-described reference detergent solution combined with a 5% of Triton X-100 (20 wt %) to obtain a calibration curve for each dye used.

The values of absorbance (of the principal peak of the different dye samples) resulting from the desorption experiments were reported as a percentage of the value of same dye desorbed using the reference detergent solution at 92° C. in the calibration procedure described above.

The following solutions were evaluated for their impact on dye bleeding for both dyed cotton fabric (cotton fabric dyed using reactive black 5, supplied by CFT under product code AISE code 21) and dyed polyester fabric (polyester fabric dyed using disperse blue 79, supplied by CFT under product code AISE code 31), and the results given below. Apart from Leg A and F (water), the solutions used in the remaining legs comprised 350 ppm of surfactant.

TABLE 2
% Desorption @ 40 0C (after 1 hour) vs. desorption at 92° C.
using the reference detergent solution for cotton fabrics

| | | % desorption |
|---|---|---|
| | | of reactive |
| | | black 5 dye |
| Leg | Test solution | from cotton |
| A | water¹ | 46.8 |
| B | reference detergent solution² | 64.9 |
| C | linear C12-C14 EO7³ | 72.4 |
| D | 2-propyl-1-heptyl EO7⁴ | 51.1 |
| E | 2-propyl-1-heptyl (PO)3(EO)12(PO)15⁵ | 47.4 |

¹hardness 2.67 mmol CaCO₃ equivalence (15 gpg)
²1:1:1 weight ratio of linear C10-C13 alkylbenzene sulphonic acid (HLAS), linear C12-C15 alkyl ethoxylate (3.0) sulphate (AE3.0S), and linear C12-C14 alkyl-7-ethoxyleate (Lordac ® L726, supplied by Sasol)
³Lordac ® L726, supplied by Sasol
⁴Lutensol ® XP70, supplied by BASF
⁵Plurafac ® SLF180, supplied by BASF

TABLE 3
% Desorption @ 40° C. (after 1 hour) vs. desorption at 92° C.
using the reference detergent solution for polyester fabrics

| | | % desorption of |
|---|---|---|
| | | disperse blue 79 |
| | | dye from |
| Leg | Test solution | polyester |
| F | water¹ | 8.5 |
| G | reference detergent solution² | 50.3 |
| H | linear C12-C14 EO7³ | 65.7 |
| I | 2-propyl-1-heptyl EO7⁴ | 10.3 |
| J | 2-propyl-1-heptyl (PO)3(EO)12(PO)15⁵ | 12.4 |

The effect on detergents on dye bleeding from fabric during laundering can be seen from comparing the dye desorption results in Table 1 for leg B with leg A for cotton fabrics and results in Table 3 comparing leg G with leg F for polyester fabrics.

From comparing the dye-bleeding from legs D and E with leg C, it can be seen that branched nonionic surfactants provide reduced dye bleeding than linear branched nonionic surfactants when laundering cottons. A comparison of legs I and J with leg H demonstrates the same benefit for branched nonionics when laundering polyester fabrics.

From legs B and G, it can be seen that dye bleeding is lower for both cotton and polyester fabrics when the wash temperature is reduced (from 92° C. to 40° C.).

The following methodology was used to evaluate the impact of branched and linear nonionic surfactants on dye redeposition during laundering.

The following detergent compositions were preparedby mixing the ingredients. Examples 1 and 2 were of the present invention, while example A comprised linear nonionic surfactant instead of a branched nonionic surfactant and hence was comparative.

TABLE 4
Examples 1 and 2 of the present invention, and comparative
example A

| | Ex 1 | Ex A* |
|---|---|---|
| | wt % | wt % |
| C10-C13 linear alkyl benzene sulphonate | 4.0 | 4.0 |
| C12-C15 AE3.0S | 4.0 | 4.0 |
| C12-14 secondary alcohol EO7¹ | 6.0 | — |
| linear C12-C14 EO7² | — | 6.0 |
| Fatty Acid | 1.0 | 1.0 |
| Graft copolymer dye transfer inhibitor³ | 0.4% | 0.4% |

¹Softanol 70, supplied by NSCL
²naturally derived, sold under the tradename AEO7 by JINTUNG Petrochemical Co., ltd, China
³ Example 1K of WO2020005476A, supplied by BASF

The tests were carried out in a Tergotometer (Model: RHLQ1V, from Research Institute of Daily Chemical Industry (RIDCI)) using the following protocol:
1. 990 ml of water at room temperature and having a hardness of 2.67 mmol CaCO₃ equivalence (15 gpg) was added to the tergometer pot.
2. 2 g of the respective detergent composition was added to the water and the solution was agitated for 3 minutes.
3. three fabric swatches of 8 cm×8 cm nil brightener heavy cotton (such as cw98, supplied by Daxing Textile Co., China) were prepared and the L/a/b values for each fabric piece was measured using a Spetro-Guide 45/0 Gloss 6801 color spectrophotometer.
4. The three pieces of heavy cotton fabric were then added to the tergometer pot and the contents of the pot agitated for another 3 minutes.
5. 10 ml of a 250 ppm aqueous solution of Direct Red 227 dye (supplied by SUN DAT DYESTUFFS LIMITED, China) was added to the tergometer pot such that the wash liquor comprised 2.5 ppm of the dye, and the pot agitated for 5 minutes.
6. The fabric swatches were removed from the tergometer pot and thoroughly rinsed under running tap water (2.85 mmol/1 Ca equivalent, 16 gpg).
7. The fabric swatches were line dried overnight at room temperature.
8. The L/a/b values of each dried fabric swatch was remeasured using the same Spetro-Guide 45/0 Gloss 6801 color spectrophotometer;

The ΔE (CIELab) change between the average L/a/b values before and after washing on fabric provided an assessment of dye deposition from the wash liquor on to the fabric swatches, and hence an assessment of the ability of the detergent composition to prevent dye redeposition. A lower AE demonstrates a greater efficacy in preventing dye redeposition during the wash process.

TABLE 5
AE colour change after wash cycle

| | | ΔE |
|---|---|---|
| | | (lower the |
| Ex | Nonionic surfactant | better) |
| 1 | C12-14 secondary alcohol EO7¹ | 14.1 |
| A | Linear C12-C14 EO7² | 15.2 |

As can be seen from the results in Table 5, treatment of fabrics with the combination of branched nonionic surfactant and the graft polymer dye transfer inhibitor, of use in the present invention, results in lower AE values and therefore reduced dye redeposition onto fabric during the laundry cycle.

TABLE 6
Examples of compositions of the present invention.

| | Ex 2 | Ex 3 | Ex 4 | Ex 5 | Ex 6 | Ex 7 |
|---|---|---|---|---|---|---|
| | wt % | wt % | wt % | wt % | wt % | wt % |
| C10-C13 linear alkyl benzene | 4.0 | 3.0 | 4.0 | 4.3 | 4.3 | 7 |
| sulphonic acid | | | | | | |
| C12-C15 alkyl polyethoxylate | 4.0 | 3.0 | 3.0 | 3.0 | 3.0 | 16 |
| sulphate | | | | | | |
| C12-14 secondary alcohol EO7¹ | 1.0 | 8.0 | 2.0 | 7.4 | 3.0 | 2.5 |
| C14-15 alkyl-7-ethoxylate7⁴ | — | — | 1.0 | 2.6 | 2.6 | — |
| C12-C14 dimethyl aminoxide | — | 0.5 | 0.4 | 0.4 | 0.4 | 1.3 |
| C12-C18 Fatty Acid | 1.0 | 0.5 | 2.0 | 2.5 | 2.5 | 3.6 |
| Citric Acid | 1.0 | 0.5 | 1.5 | 2.0 | 2.0 | 4.2 |
| Cleaning polymer⁵ | — | — | — | — | 0.3^{c} | 3^{d} |
| Graft copolymer dye transfer | 0.5 | 1.0 | 1.0 | 0.6 | 0.3 | 1.5 |
| inhibitor³ | | | | | | |
| Enzymes | 0.001 | 0.001 | 0.001 | 0.03 | 0.03 | 0.18 |
| Water and miscellaneous | to 100% | to 100% | to 100% | to 100% | to 100% | to 100% |

⁴Neodol 45-7, supplied by Shell
⁵600 g/mol molecular weight polyethylenimine core with 20 ethoxylate groups per —NH and available from BASF (Ludwigshafen, Germany)

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising a surfactant system and dye transfer inhibition (DTI) polymer, wherein the surfactant system comprises: a branched nonionic surfactant, and wherein the dye transfer inhibition polymer is a graft copolymer, the graft copolymer comprising:
a. polyalkylene oxide which has a number average molecular weight of from about 1000 to about 20,000 Daltons and is based on ethylene oxide, propylene oxide, or butylene oxide;
b. N-vinylpyrrolidone; and
c. vinyl ester derived from a saturated monocarboxylic acid containing from 1 to 6 carbon atoms and/or a methyl or ethyl ester of acrylic or methacrylic acid;
wherein the weight ratio of (a):(b) is from about 1:0.1 to about 1:2, and
wherein the amount, by weight, of (a) is greater than the amount of (c);
wherein the branched nonionic surfactant selected from:
a) R1-CH(R2)-O—(PO)ₓ(EO)_{y}(PO)_{z}—H Formula I:
wherein in Formula I:
R1 is a C4 to C14 alkyl chain;
R2 is a C1 to C7 alkyl chain;
x is from about 0 to about 10;
y is from about 5 to about 20;
z is from about 0 to about 20;
EO stands for ethoxylation and PO stands for propoxylation;
b) R1-CH(R2)CH2-O—(PO)ₓ(EO)_{y}(PO)_{z}—H Formula II:
wherein in formula II:
R1 is a C3 to C13 alkyl chain;
R2 is a C1 to C7 alkyl chain;
x is from about 0 to about 10;
y is from about 5 to about 20;
z is from about 0 to about 20;
EO stands for ethoxylation and PO stands for propoxylation.

2. The laundry detergent composition according to claim 1, wherein:
a) in formula I:
R1 is a C4 to C8 alkyl chain;
R2 is a C1 to C5 alkyl chain;
x is from about 0 to about 5;
y is from about 6 to about 15; and
z is from about 0 to about 5;
b) in formula II:
R1 is a C3 to C7 alkyl chain;
R2 is a C1 to C5 alkyl chain;
x is from about 0 to about 6;
y is from about 6 to about 15;
z is from about 0 to about 5.

3. The laundry detergent composition according to claim 1, wherein surfactant system comprises the branched nonionic surfactant at a level of from about 0.1% to about 12% by weight of the composition.

4. The laundry detergent composition according to claim 3, wherein surfactant system comprises the branched nonionic surfactant at a level of from about 0.5% to about 10% by weight of the composition.

5. The laundry detergent composition according to claim 1, wherein the laundry composition comprises the surfactant system at a level of from about 1 wt % to about 70 wt %.

6. The laundry detergent composition according to claim 1, wherein the surfactant system further comprises an anionic surfactant, wherein the anionic surfactant comprises: sulphonate surfactant, sulphate surfactant, and mixtures thereof.

7. The laundry detergent composition according to claim 6, wherein the anionic surfactant comprises alkyl sulphate surfactant, wherein the alkyl sulphate surfactant has an average degree of ethoxylation of from about 0.5 to about 8.0.

8. The laundry detergent composition according to claim 6, wherein the anionic surfactant comprises alkyl sulphate surfactant, wherein the alkyl sulphate surfactant has an average degree of ethoxylation of less than 0.5.

9. The laundry detergent composition according to claim 8, wherein the alkyl sulphate surfactant comprises branched alkyl sulphate surfactant, wherein the branched alkyl sulphate surfactant comprises at least about 20% by weight of the alkyl chains of the branched alkyl sulphate surfactant of 2-branched alkyl chains.

10. The laundry detergent composition according to claim 1, wherein the surfactant system comprises amphoteric and/or zwitterionic surfactant, wherein the amphoteric surfactant is selected from amine oxide surfactant.

11. The laundry detergent composition according to claim 10, wherein the amine oxide surfactant is lauryl dimethylamine oxide.

12. The laundry detergent composition according to claim 1, wherein the graft polymer is present at a level of from about 0.05% to about 15% by weight of the detergent composition.

13. The laundry detergent composition according to claim 12, wherein the graft polymer is present at a level of from about 0.1% to about 3.0% by weight of the detergent composition.

14. The laundry detergent composition according to claim 1, wherein in the graft polymer
a) the polyalkylene oxide comprises ethylene oxide units, and
c) the vinyl ester comprises vinyl acetate.

15. The laundry detergent composition according to claim 1, wherein in the graft polymer, the weight ratio of (a):(c) is from about 1.0:0.1 to about 1.0:0.99.

16. The laundry detergent composition according to claim 1, wherein in the graft polymer, from about 1.0 mol % to about 60 mol % of the grafted-on monomers of component (c) are hydrolysed.

17. The laundry detergent composition according to claim 1, wherein the graft polymer has a weight average molecular weight of from about 5,000 Da to about 100,000 Da.

18. The laundry detergent composition according to claim 17, wherein the graft polymer has a weight average molecular weight of from about 5,000 Da to about 50,000 Da.

19. The laundry detergent composition according to claim 1, wherein the composition further comprises polymer deposition aid, dye fixative polymer, and mixtures thereof.

20. The laundry detergent composition according to claim 1, wherein:
the dye transfer inhibition polymer is a graft copolymer, the graft copolymer comprising:
a. polyalkylene oxide consists of ethylene oxide units, and has a number average molecular weight of from about 1000 to about 20,000 Daltons;
b. N-vinylpyrrolidone; and
c. vinyl ester which is vinyl acetate;
wherein the weight ratio of (a):(b) is from about 1:0.1 to about 1:2, and
wherein the amount, by weight, of (a) is greater than the amount of (c);
wherein the graft polymer has a weight average molecular weight of from about 5,000 Da to about 50,000 Da;
wherein the graft polymer is present at a level of from about 0.1% to about 3.0% by weight of the detergent composition;
the surfactant system comprises:
a branched nonionic surfactant selected from:
a) R1-CH(R2)-O—(PO)ₓ(EO)_{y}(PO)_{z}—H Formula I:
wherein, in Formula I:
R1 is a C4 to C8 alkyl chain;
R2 is a C1 to C5 alkyl chain;
x is from about 0 to about 5;
y is from about 6 to about 15; and
z is from about 0 to about 5; and
b) R1-CH(R2)CH2-O—(PO)ₓ(EO)_{y}(PO)_{z}—H Formula II:
wherein in formula II:
R1 is a C3 to C7 alkyl chain;
R2 is a C1 to C5 alkyl chain;
x is from about 0 to about 6;
y is from about 6 to about 15;
z is from about 0 to about 5;
the surfactant system further comprises anionic surfactant and amphoteric surfactant, wherein:
the anionic surfactant comprises: sulphonate surfactant and sulphate surfactant; and
the amphoteric surfactant is selected from amine oxide surfactant.
